(19) United States
(12) Patent Application Publication
(10) Pub. No.: US 2026/0205217 A1
(43) Pub. Date: Jul. 16, 2026

(54) DEVICE AND COMPUTER-IMPLEMENTED METHOD FOR OPERATING A MOBILE TERMINAL, AND DEVICE AND METHOD FOR SUPPORTING THE MOBILE TERMINAL IN SAID METHOD

(71) Applicant: Robert Bosch GmbH, Stuttgart (DE)

(72) Inventors: Hugues Narcisse Tchouankem, Hemmingen (DE); Maximilian Stark, Hamburg (DE)

(21) Appl. No.: 19/135,688

(22) PCT Filed: Nov. 29, 2023
(86) PCT No.: PCT/EP2023/083496

§ 371 Date: Jun. 4, 2025

(30) Foreign Application Priority Data
Dec. 7, 2022 (DE) 10 2022 213 214.9

(51) Int. Cl. H04B 17/391; H04W 24/02

(52) U.S. Cl. CPC H04B 17/3913; H04W 24/02

(57) ABSTRACT

The invention relates to a device and a computer-implemented method for operating a mobile terminal (102-1), wherein a variable characterizing a radio connection between the mobile terminal (102-1) and an access point of a telecommunications network is determined in the mobile terminal (102-1), wherein a model (204) that is designed to predict a property of the radio connection and/or of a radio connection between the mobile terminal (102-1) and another access point of the telecommunications network according to the variable and according to at least one model parameter is used in the mobile terminal (102-1) to determine a prediction of the property according to the variable and the at least one model parameter, wherein a reference variable characterizing the radio connection for which the prediction was determined is determined in the mobile terminal (102-1), wherein a measure of a quality of the prediction is determined in the mobile terminal (102-1) according to the prediction and the reference variable, wherein the measure is transmitted by the mobile terminal (102-1) to a receiver outside the mobile terminal (102-1), wherein the mobile terminal (102-1) receives, from a transmitter outside the mobile terminal (102-1), at least one model parameter for the model (204) that was determined outside the mobile terminal (102-1) according to the measure of the quality, wherein at least one of the model parameters of the model (204) is replaced in the mobile terminal (102-1) with the at least one model parameter for the model (204). The invention also relates to a device and a method for supporting the mobile terminal (102-1) in the method for operating the mobile terminal (102-1).

A device and method for operating a mobile terminal. A variable characterizing a radio connection between the mobile terminal and an access point of a telecommunications network is determined in the mobile terminal. A model configured to predict a property of the radio connection and/or of a radio connection between the mobile terminal and another access point of the telecommunications network according to the variable and according to a model parameter is used in the mobile terminal to determine a prediction of the property according to the variable and the model parameter. A reference variable characterizing the radio connection for which the prediction was determined is determined in the mobile terminal. A measure of a quality of the prediction is determined in the mobile terminal according to the prediction and the reference variable. The measure is transmitted by the mobile terminal to a receiver outside the mobile terminal.

### FIELD

The present invention relates to a device and a computer-implemented method for operating a mobile terminal, and to a device and a method for supporting the mobile terminal in the method.

### BACKGROUND INFORMATION

Conventionally, a passive measurement of a property of a radio connection is performed by the mobile terminal itself and used to predict a property of the radio connection.

### SUMMARY

A computer-implemented method for operating a mobile terminal according to an example embodiment of the present invention provides that a variable characterizing a radio connection between the mobile terminal and an access point of a telecommunications network is determined in the mobile terminal, wherein a model that is designed to predict a property of the radio connection and/or of a radio connection between the mobile terminal and another access point of the telecommunications network according to the determined variable and according to at least one model parameter is used in the mobile terminal to determine a prediction of the property according to the determined variable and the at least one model parameter, wherein a reference variable characterizing the radio connection(s) for which the prediction was determined is determined in the mobile terminal, wherein a measure of a quality of the prediction is determined in the mobile terminal according to the prediction and the reference variable, wherein the measure is transmitted by the mobile terminal to a receiver outside the mobile terminal, wherein the mobile terminal receives, from a transmitter outside the mobile terminal, at least one model parameter for the model that was determined outside the mobile terminal according to the measure of the quality, wherein at least one of the model parameters of the model is replaced in the mobile terminal with the at least one model parameter for the model. The model is thus trained in a distributed manner, i.e., with a learning step that takes place outside the mobile terminal. This means that, in the learning step, the model parameters of the local model of the mobile terminal are determined in a central learning unit.

For inference, a further variable is determined in the mobile terminal, and wherein a further prediction is determined in the mobile terminal according to the further variable and the model in which the at least one model parameter for the model replaces the at least one model parameter of the model, wherein the further variable and the further prediction characterize the radio connection between the mobile terminal and the access point and/or the radio connection between the mobile terminal and the other access point and/or a further radio connection between the mobile terminal and another access point of the telecommunications network.

According to an example embodiment of the present invention, the variable is preferably determined at a first point in time and at a first location, wherein the prediction is determined for a second point in time and for a second location, wherein the reference variable is determined at the second point in time and at the second location, or wherein the further variable is determined at a third point in time and at a third location, and wherein the further prediction is determined for a fourth point in time and for a fourth location.

According to an example embodiment of the present invention, preferably, the model is used in the mobile terminal to determine a first estimate of the property for a specified location according to the variable or the further variable, wherein a second estimate of the property for the specified location is received in the mobile terminal from a transmitter outside the mobile terminal, wherein the second estimate was determined outside the mobile terminal according to a variable characterizing a radio connection between another mobile terminal and its access point to the telecommunications network, and wherein the prediction is determined according to the first estimate and the second estimate. The prediction is thus determined in collaboration with another mobile terminal. In particular, this allows for a more robust prediction when the first mobile terminal moves from one cell of a cell-based telecommunications network in which the first mobile terminal is located to another cell of this telecommunications network in which the other mobile terminal is located.

The first estimate is preferably determined with a first part of the model, wherein the prediction is determined with a second part of the model according to the first estimate and the second estimate.

The second part of the model is preferably designed to weight the first estimate according to a weight, wherein the weight is determined according to an age of the first estimate and the prediction is determined according to the first estimate weighted by the weight, and/or that the second part of the model is designed to weight the second estimate according to a weight, wherein the weight is determined according to an age of the second estimate and the prediction is determined according to the second estimate weighted by the weight. This further increases the quality of the prediction.

According to an example embodiment of the present invention, preferably, the mobile terminal receives a third estimate of the property for the specified location from the transmitter or another transmitter outside the mobile terminal, wherein an age of the third estimate is determined, and wherein the prediction is determined according to the third estimate instead of the second estimate if the age of the third estimate is more recent than the age of the second estimate. This further improves the prediction.

The variable preferably characterizes the radio connection in a first cell of a cell-based telecommunications network and the further variable characterizes the radio connection in the first cell or a second cell of the cell-based telecommunications network. The prediction is thereby determined for the same cell or another cell.

A computer-implemented method according to an example embodiment of the present invention for supporting a mobile terminal in a method for operating the mobile terminal provides that a measure of a quality of a prediction of a property of a radio connection between a mobile terminal and an access point of the telecommunications network is received, wherein the measure is determined according to a prediction and a reference variable for the property, wherein the prediction was determined in the mobile terminal with a model that has at least one model parameter, wherein at least one model parameter for the model is determined outside the mobile terminal according to the measure and according to at least one further measure of a quality of a prediction of a property of a radio connection between a further mobile terminal and its access point to the telecommunications network, wherein the at least one model parameter for the model is transmitted from a transmitter outside the mobile terminal to the mobile terminal. During training, the mobile terminal is supported in distributed learning by centrally determining the model parameters.

According to an example embodiment of the present invention, preferably, a variable characterizing the radio connection between another mobile terminal and its access point to the telecommunications network is received and transmitted to the mobile terminal. During training, by forwarding this variable, the mobile terminal is supported in determining the reference variable for determining the measure of the quality, if the prediction is determined for a location where the other mobile terminal determines the variable.

According to an example embodiment of the present invention, preferably, an estimate of the property characterizing the radio connection between another mobile terminal and its access point to the telecommunications network at a specified location is received and transmitted to the mobile terminal.

The mobile terminal is designed to carry out the method according to the present invention for operating the mobile terminal.

The device for supporting the mobile terminal in the method for operating the mobile terminal is designed to carry out the method for supporting according to an example embodiment of the present invention.

A computer program comprising computer-executable instructions that, when executed by the computer, cause the respective method of the present invention to run, and a corresponding computer-readable medium on which the computer program is stored have advantages corresponding to the advantages of these methods of the present invention.

Further advantageous example embodiments of the present invention can be found in the following description and the figures.

### BRIEF DESCRIPTION OF THE DRAWINGS

FIG. 1 is a schematic representation of a telecommunications network.

FIG. 2 is a schematic representation of a first example embodiment of a system for operating a mobile terminal, according to the present invention.

FIG. 3 shows steps in a method according to the first example embodiment of the present invention.

FIG. 4 is a schematic representation of a second example embodiment of the system for operating the mobile terminal, according the present invention.

FIG. 5 is a schematic representation of a third example embodiment of the system for operating the mobile terminal, according to the present invention.

### DETAILED DESCRIPTION OF EXAMPLE EMBODIMENTS

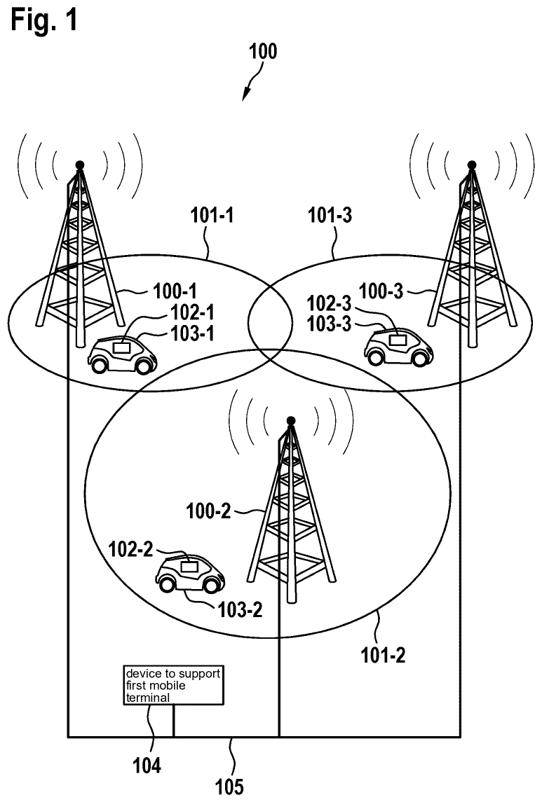

FIG. 1 schematically shows a telecommunications network 100.

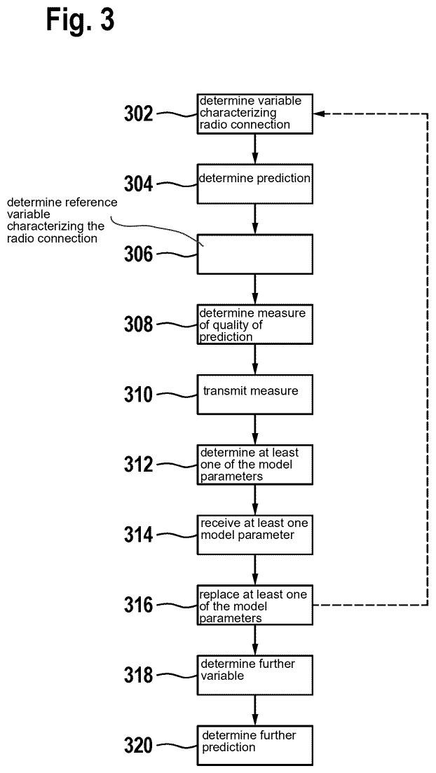

The telecommunications network 100 comprises a plurality of access points, of which a first access point 100-1, a second access point 100-2 and a third access point 100-3 are shown in FIG. 3.

The telecommunications network 100 is a cell-based telecommunications network 100, wherein one cell is defined for each access point in the example. The first access point 100-1 provides a first cell 101-1. The second access point 100-2 provides a second cell 101-2. The third access point 100-3 provides a third cell 101-3.

In the example, the cells partially overlap one another. Via the first access point 100-1, the first cell provides a mobile terminal located in the first cell with a radio connection to a service offered in the telecommunications network 100. Via the second access point 100-2, the second cell provides a mobile terminal located in the second cell with a radio connection to the service. Via the third access point 100-1, the third cell provides a mobile terminal located in the third cell with a radio connection to the service. In the example, a mobile terminal is located, depending on its position, in one or more of the cells. In the example, a mobile terminal is connected to one of the access points.

In the example, a first vehicle 103-1 is shown, which comprises the first mobile terminal 101-1. In the example, the first mobile terminal 101-1 is integrated in the first vehicle 103-1. In the example, a second vehicle 103-2 is shown, which comprises the second mobile terminal 101-2. In the example, the second mobile terminal 101-2 is integrated in the second vehicle 103-2. In the example, a third vehicle 103-3 is shown, which comprises the third mobile terminal 101-3. In the example, the third mobile terminal 101-3 is integrated in the third vehicle 103-3. A quality with which the service is available at a position of a mobile terminal in a cell, i.e., a quality of service, Qos, is characterized, e.g., by a variable characterizing a radio connection between the mobile terminal and an access point of a telecommunications network 100.

The quality is characterized, e.g., by a bandwidth of the transmission over the radio connection at the position.

The quality is characterized, e.g., by an indicator for a received field strength at the position. For example, the radio connection is provided with a reference signal of the received field strength at the mobile terminal, RSRP, which characterizes the quality.

The quality is characterized, e.g., by an indicator for a received power in a frequency channel of the radio connection.

For example, the radio connection is provided with a received broadband power in the frequency channel including thermal noise, RSSI, which characterizes the quality.

The quality is characterized, e.g., by a calculated ratio value resulting from the value for RSRP and the RSSI. For example, the radio connection is provided with a ratio value RSRQ which is calculated from them and characterizes the quality.

RSRP, RSSI, and RSRQ are defined, e.g., according to the 3rd Generation Partnership Project, 3GPP, Release 15. RSRP and RSSI can be measured in the mobile terminal. Other variables that can be measured in the mobile terminal and that characterize the QoS can also be used. Other variables that characterize the QoS and are measured outside the mobile terminal and provided to the mobile terminal via a service outside the mobile terminal and an application, such as MobileInsight, in the mobile terminal can also be used.

MobileInsight is described, e.g., in: “Mobileinsight: extracting and analyzing cellular network information on smartphones,” Yuanjie Li, Chunyi Peng, Zengwen Yuan, Jiayao Li, Haotian Deng, Tao Wang, MobiCom '16: Proceedings of the 22nd Annual International Conference on Mobile Computing and Networking, October 2016, pages 202-215, dl. acm. org/doi/10.1145/2973750.2973751.

In the example, a first mobile terminal 102-1 is located in the first cell 101-1. In the example, a second mobile terminal 102-2 is located in the second cell 101-2. In the example, a third mobile terminal 102-3 is located in the third cell 101-3.

The first mobile terminal 102-1 is designed to carry out a method for operating the first mobile terminal 102-1.

In the example, the telecommunications network 100 comprises a device 104 designed to support the first mobile terminal 102-1 in this method. The device 104 is connected, e.g., via an optical or wired communication link 105 to the first access point 101-1, the second access point 101-2 and the third access point 101-3.

It may be provided that the second mobile terminal 102-2 is designed to carry out the method for operating the second mobile terminal 102-2. It may be provided that the second mobile terminal 102-2 is designed to support the first mobile terminal 102-1 in carrying out the method without the second mobile terminal 102-2 itself carrying out the method. It may be provided that the third mobile terminal 102-3 is designed to carry out the method for operating the third mobile terminal 102-3. It may be provided that the third mobile terminal 102-3 is designed to support the first mobile terminal 102-1 in carrying out the method without the third mobile terminal 102-3 itself carrying out the method.

In the method for operating the first mobile terminal 102-1, the first mobile terminal 102-1 detects at least one variable characterizing the quality of the radio connection to an access point that is reachable by the first mobile terminal 102-1. In the method, the first mobile terminal 102-1 determines a prediction of the quality of the radio connection between the first mobile terminal 102-1 and at least one access point of the telecommunications network 100. The access point is, e.g., the access point currently used by the first mobile terminal 102-1 for its radio connection to the telecommunications network 100 or another access point that could be used currently or in the future.

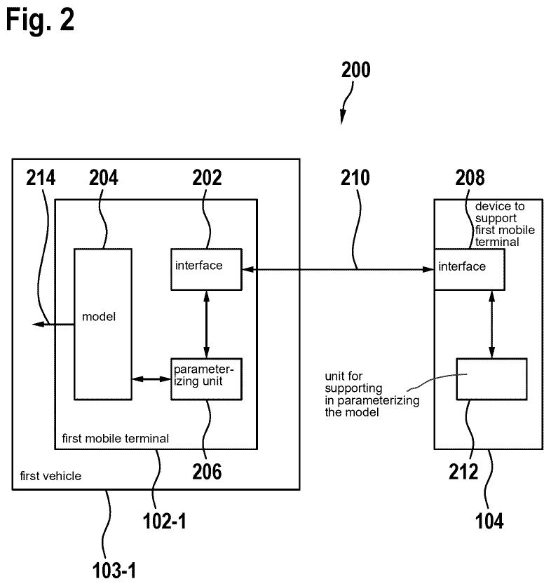

FIG. 2 schematically shows a system 200 for operating a mobile terminal according to a first embodiment.

The first embodiment is described below with reference to the example of the first mobile terminal 102-1 integrated in the first vehicle 103-1. The system 200 comprises the first mobile terminal 102-1 and the device 104.

The first mobile terminal 102-1 comprises an interface 202 for the radio connection, a model 204 for predicting a property of the radio connection, and a unit 206 for parameterizing the model 204. The model 204 comprises at least one model parameter. The model 204 is designed to determine the prediction according to at least one model parameter and according to the variable and the at least one model parameter. The unit 206 for parameterizing the model 204 is designed to determine at least one of the model parameters in the model 204.

The device 104 comprises an interface 208 for communication with the first mobile terminal 102-1 via a communication link 210 to the interface 202 in the first mobile terminal 102-1. The device 104 comprises a unit 212 for supporting in parameterizing the model 204.

In the first embodiment, the model 204 comprises an artificial neural network whose weights are defined by the model parameters. The unit 206 for parameterizing the model 204 is designed, e.g., to determine at least one of the model parameters in the artificial neural network.

The unit 212 for supporting in parameterizing the model 204 is designed to determine the at least one model parameter in an optimization method in which a loss function is minimized with a gradient descent method. In the example, the loss function is defined according to the measure.

The unit 212 for supporting in parameterizing the model 204 is designed to receive from a plurality of mobile terminals designed to determine a respective measure of the quality of their radio connection to the telecommunications network 100. The unit 212 for supporting in parameterizing the model 204 is designed to minimize the loss function according to these measures. The loss function is, e.g., a mean of the measures. The unit 212 for supporting in parameterizing the model 204 is designed to determine gradients for the gradient descent method according to the loss function and to determine the at least one model parameter for which the gradient is smaller than a threshold.

It may be provided that the unit 212 for supporting in parameterizing the model 204 is designed to transmit the at least one model parameter to the plurality of mobile terminals. The plurality of mobile terminals includes, for example, the second mobile terminal 102-2 and/or the third mobile terminal 102-3.

The device 104 comprises an output 214 for the prediction.

FIG. 3 shows steps of a first embodiment of a computer-implemented method for operating the first mobile terminal 102-1. In a step 302, the variable characterizing the radio connection between the first mobile terminal 102-1 and an access point of the telecommunications network 100 is determined in the first mobile terminal 102-1.

RSRP or RSSI is measured, e.g., as a variable or RSRQ as a variable is calculated from them. It may also be provided that the variable is another variable that can be measured in the first mobile terminal 102-1 and characterizes the QoS. It may also be provided that the variable is another variable that is measured outside of the first mobile terminal 102-1 and characterizes the Qos, and is provided to the first mobile terminal 102-1 via the service outside the mobile terminal and the application, such as, e.g., Mobilelnsight, in the first mobile terminal 102-1.

In the example, the variable characterizes the radio connection between the first mobile terminal 102-1 and the first access point 100-1.

In the example, the variable is determined at a first point in time and at a first location. The first location is the position of the first mobile terminal 102-1 at the first point in time and corresponds to the position of the first vehicle 103-1 at the point in time at which the variable is determined.

In a step 304, the prediction is determined in the first mobile terminal 102-1 with the model 204. In the example, the prediction is determined for a second point in time and for a second location. The second location is the position of the first mobile terminal 102-1 at the second point in time and corresponds to the position of the first vehicle at the second point in time.

The prediction of the property of the radio connection via which the first mobile terminal 102-1 is connected to the first access point 100-1 is determined in one example.

Instead or in addition thereto, it may be provided that the prediction of the property of a radio connection between the first mobile terminal 102-1 and another access point of the telecommunications network 100, e.g., the second access point 100-2 or the third access point 100-3, is determined.

In a step 306, a reference variable characterizing the radio connection for which the prediction was determined is determined in the first mobile terminal 102-1. The reference variable in the example characterizes the same property as the variable, i.e., both the variable and the reference variable are, for example, bandwidth, RSRP or RSSI or RSRQ or one of the other variables that are measured or provided.

In the example, the reference variable is determined at the second point in time and at the second location. In the example, the second point in time or the second location at which the reference variable is determined and the second point in time or the second location for which the prediction is determined match exactly or at least substantially. It may be provided that the second point in time or the second location at which the reference variable is determined and the second point in time or the second location for which the prediction is determined differ from one another by a given tolerance.

The point in time and the location for determining the reference variable is determined, for example, according to a planned route of the first vehicle in which the first mobile terminal 102-1 is arranged. The point in time is, for example, the exact absolute point in time or a comparable point in time, e.g., the same time on a different day or the same day in a different year. The reference variable can also be determined at another point in time within a specified period of time that comprises the point in time.

It may be provided that a variable characterizing the radio connection between another mobile terminal and its access point to the telecommunications network 100 is received, and the reference variable is determined on the basis thereof.

It may be provided that the telecommunications network 100, in particular the device 104, receives this variable from the other mobile terminal and transmits it to the mobile terminal 102-1.

In a step 308, a measure of a quality of the prediction is determined in the first mobile terminal 102-1 according to the prediction and the reference variable.

For example, a deviation, in particular a difference between the prediction and the reference variable, is determined.

In a step 310, the measure is transmitted from the first mobile terminal 102-1 to a receiver outside the first mobile terminal 102-1.

In the example, the receiver is the device 104. In the example, the measure is transmitted from the interface 202 in the first mobile terminal 102-1 to the interface 208 in the device 104.

It may be provided that the measure is received from a plurality of mobile terminals designed to determine a respective measure of the quality of their radio connection to the telecommunications network 100.

In a step 312, at least one of the model parameters is determined outside the first mobile terminal 102-1.

In the example, the at least one model parameter is determined by the device 104.

The at least one model parameter is determined according to the measure received from the first mobile terminal 102.

In the example, the at least one model parameter is determined in the optimization method in which the loss function is minimized with the gradient descent method. In the example, the loss function is defined according to the measure received from the first mobile terminal 102-1.

It may be provided that the loss function is defined according to the plurality of the measures. The loss function is, for example, the mean of these measures. The gradients for the gradient descent method are determined, for example, according to the loss function. At least one model parameter for which the gradient is smaller than the threshold is determined in the example.

In a step 314, at least one model parameter for the model 204 is received by the first mobile terminal 102-1. This means that the first mobile terminal 102-1 receives the model parameter from a transmitter outside the first mobile terminal 102-1.

It may be provided that the unit 212 for supporting in parameterizing the model 204 is designed to determine the at least one model parameter and to transmit it to the plurality of mobile terminals, including the first mobile terminal 102-1.

In the example, the transmitter is the device 104. In the example, at least one model parameter is transmitted from the interface 208 in the device 104 to th interface 202 in the first mobile terminal 1e02-1.

In a step 316, at least one of the model parameters of the model 204 is replaced in the first mobile terminal 102-1 by the at least one model parameter for the model 204.

The model 204 is trained through steps 302 to 316. These steps can be repeated in order to train the model 204 further.

It may be provided that the method ends thereafter.

In the example, it is provided to use the model 204.

In a step 318, a further variable is determined in the first mobile terminal 102-1. In one example, the further variable characterizes the radio connection between the first mobile terminal 102-1 and the first access point 100-1. It may be provided that the further variable instead characterizes the radio connection between the first mobile terminal 102-1 and the other access point, e.g., the second access point 100-2 or the third access point 100-3.

In a step 320, a further prediction is determined in the first mobile terminal 102-2 according to the further variable and the model 204.

In the model 204, the at least one model parameter for the model 204 replaces the at least one model parameter of model 204.

In the example, the further prediction characterizes the radio connection between the first mobile terminal 102-1 and the first access point 100-1. It may be provided that the further variable characterizes the radio connection between the first mobile terminal 102-1 and the other access point, e.g., the second access point 100-2 or the third access point 100-3.

In the example, the further variable is determined at a third point in time and at a third location. In the example, the further prediction is determined for a fourth point in time and for a fourth location.

In the example, the variable characterizes the radio connection in the first cell 101-1. In the example, the further variable characterizes the radio connection in the first cell 101-1. It may also be provided that the further variable characterizes the radio connection in the second cell 101-2 or the third cell 101-3.

The device 104 is, for example, a central server. It may be provided that the device 104 is designed to provide a part of the server for each cell.

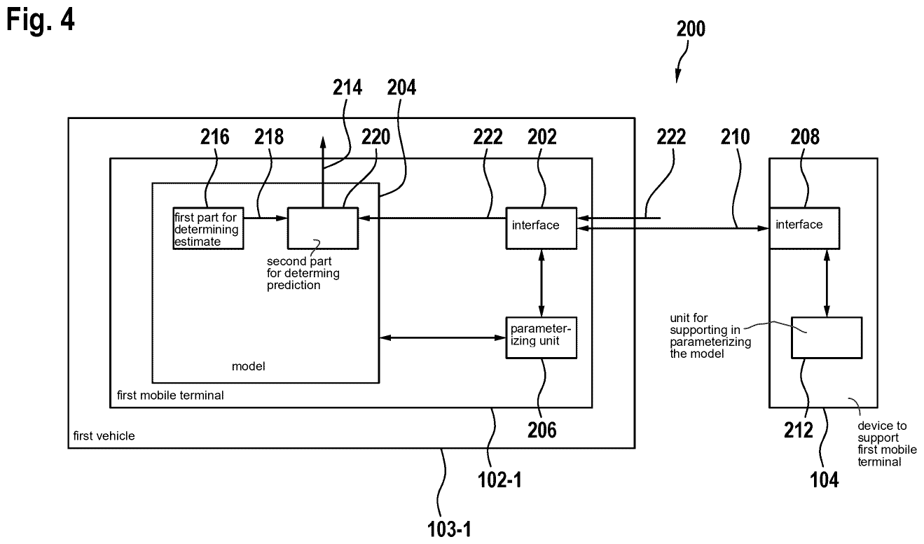

FIG. 4 schematically shows the system 200 for operating a mobile terminal according to a second embodiment. The elements included in both embodiments are denoted in FIG. 4 by the same reference signs as in FIG. 2.

The second embodiment is in particular suitable for using information about a radio connection to an access point of the telecommunications network 100 that is not directly reachable by the first mobile terminal 102-1 at the point in time or at the location of the determination of the prediction. The corresponding method is designed accordingly.

For example, the first mobile terminal 102-1 is located in the first cell 101-1 outside the second cell 101-2. For example, the second mobile terminal 102-2 is located in the second cell 101-2 and is able to evaluate the radio connection at its current location to the second access point 100-2.

In contrast to the first embodiment, the model 204 according to the second embodiment comprises a first part 216 for determining a first estimate 218 of the property for a specified location according to a variable characterizing the radio connection between the first mobile terminal 102-1 and an access point of the telecommunications network 100.

In contrast to the first embodiment, the model 204 according to the second embodiment comprises a second part 220 for determining the prediction according to the first estimate 218 and according to a second estimate 222 of the property for the specified location, which is received from a transmitter outside the first mobile terminal 102-1, e.g., via the interface 202.

The second mobile terminal 102-2 is designed, for example, to determine the second estimate 222. The second mobile terminal 102-2 is designed, for example, to provide the second estimate 222 to other mobile terminals in the telecommunications network 100. The telecommunications network 100 is designed, for example, to receive the second estimate 222 from the second mobile terminal 102-2 and to forward it to the first mobile terminal 102-1. For example, the device 104 is designed to receive and forward the second estimate 222 for the specified location. The telecommunication network 100 is designed, for example, to transmit the second estimate 222 required for the prediction for this location. The interface 202, e.g., is designed to transmit a request for the second estimate for the specified location to the telecommunications network 100.

The second part 220 of the model 204 is designed, for example, to weight the first estimate 218 according to a weight. In one embodiment, the model 204 is designed to determine the weight according to an age of the first estimate. The second part 220 is designed, for example, to determine the prediction according to the first estimate 218 weighted by the weight.

The second part 220 of the model 204 is designed, for example, to weight the second estimate 222 according to a weight. In one embodiment, the model 204 is designed to determine the weight according to an age of the second estimate 222. The second part 220 is designed, for example, to determine the prediction according to the second estimate 222 weighted by the weight.

The first part 216 comprises, for example, an artificial neural network designed to determine the first estimate 218.

The second part 220 comprises, for example, an artificial neural network designed to map the first estimate 218 and the second estimate 220 onto the prediction.

The unit 206 for parameterizing the model 204 is designed, e.g., to determine at least one of the model parameters in the first and/or in the second artificial neural network.

The method for operating the first mobile terminal 102-1 according to the second embodiment differs in the example from the method according to the first embodiment in that, in step 304, the first estimate 218 is determined in the first mobile terminal 102-1 for a specified location, the second estimate 222 for the specified location is received from outside the first mobile terminal 102-1, and the prediction is determined in the first mobile terminal 102-1 according to the two estimates for the specified location.

Step 306 according to the second embodiment differs from step 306 according to the first embodiment in that the reference variable is determined or substantially determined at the specified location.

Step 320 according to the second embodiment differs from step 320 according to the first embodiment in that the first estimate 218 is determined in the first mobile terminal 102-1 for a specified location, the second estimate 222 for the specified location is received from outside the first mobile terminal 102-1, and the prediction is determined in the first mobile terminal 102-1 according to the two estimates for the specified location. For example, the second part 220 of the model 204 weights the first estimate 218 according to the weight for the second estimate 218. For example, the second part 220 determines this weight according to the age of the first estimate 218. This means that the prediction is determined according to the first estimate 218 weighted by this weight.

For example, the second part 220 of the model 204 weights the second estimate 222 according to the weight for the second estimate 218. For example, the second part 220 determines this weight according to the age of the second estimate 222. This means that the prediction is determined according to the second estimate 222 weighted by this weight.

It may be provided that the second part 220 of the model 204, in particular the artificial neural network representing this part, is designed to map a plurality of estimates received from outside the first mobile terminal 102-1, e.g., via the interface 202, as described for the second estimate 222, in a weighted or unweighted manner together with the first estimate 218 and the second estimate 222 onto the prediction.

In one embodiment, the telecommunications network 100, in particular the device 104, is designed to detect the prediction of a mobile terminal together with the location where this prediction was determined and to provide it to another mobile terminal as a second estimate 222. In one embodiment, it is provided to store these predictions with an identification of the cell for which the prediction was determined in an, in particular central, database and to provide the prediction as a second estimate 222 upon a request that is made by a mobile terminal and contains the identification.

A prediction, i.e., the second estimate 222, is assigned to a corresponding specified location or the corresponding cell. The prediction, i.e., the second estimate 222, may be time-independent in the second embodiment.

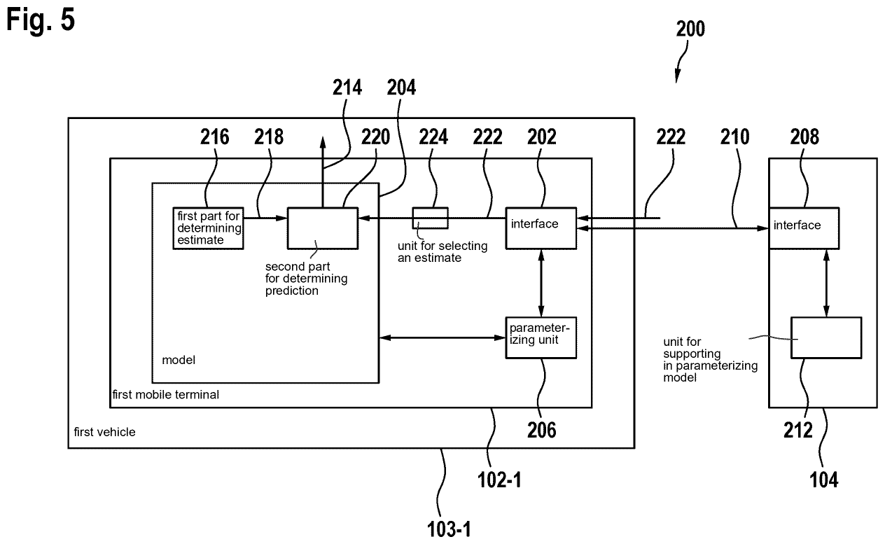

FIG. 5 schematically shows the system 200 according to a third embodiment.

In the third embodiment, the prediction, i.e., the second estimate 222, is assigned to a point in time at which the prediction was determined. The elements included in the second and third embodiments are denoted in FIG. 5 by the same reference signs as in FIG. 4.

The third embodiment is in particular suitable for using the most up-to-date information possible about a radio connection to an access point of the telecommunications network 100. The corresponding method is designed accordingly.

According to the third embodiment, the device 104 comprises a unit 224 for selecting an estimate for determining the prediction. The unit 224 for selecting the estimate is designed to determine a point in time assigned to the second estimate 222. In the example, the interface 202 is designed to receive the second estimate 222 and the point in time. The telecommunications network 100 is designed, for example, to transmit the second estimate 222 and its point in time. The interface 202, e.g., is designed to transmit a request for the second estimate, including its point in time, to the telecommunications network 100.

The unit 224 for selecting the estimate is designed to compare a current point in time, or a point in time at which the first estimate 216 applies, with the received point in time and, if the second estimate 222 is the same age as or more recent than the first estimate 216, to select the second estimate 222 for determining the prediction. The unit 224 for selecting the estimate is designed, otherwise, not to select the second estimate 222 for determining the prediction.

In an example in which multiple estimates are received from outside the first mobile terminal 102-1, it may be provided that the unit 224 is designed to select the estimate or multiple estimates that are used to determine the prediction. For example, the most recent of the estimates is selected or the estimates that are more recent than the first estimate 216 are selected.

For example, if the second mobile terminal 102-2 at a location X at a point in time t0 estimates a bandwidth of 10 Mbit as an estimate, and the third mobile terminal 102-3 at the location X at a point in time t0+x ms estimates a bandwidth of 17 Mbit, and the first mobile terminal 102-1 then reaches the location X, the first mobile terminal 102-1 uses the estimate from the third mobile terminal 102-3 as the most recent estimate.

It may also be provided to use both of these estimates if the period of time between the two estimates is less than a threshold.

1-15. (canceled)

16. A computer-implemented method for operating a mobile terminal, the method comprising the following steps:
determining, in the mobile terminal, a variable characterizing a radio connection between the mobile terminal and an access point of a telecommunications network;
determining, in the mobile terminal, using a model that is configured to predict a property of the radio connection and/or of a radio connection between the mobile terminal and another access point of the telecommunications network according to the determined variable and according to at least one model parameter, a prediction of the property according to the determined variable and the at least one model parameter;
determining, in the mobile terminal, a reference variable characterizing: (i) the radio connection between the mobile terminal and the access point and/or (ii) the radio connection between the mobile terminal and another access point, for which the prediction was determined;
determining, in the mobile terminal, a measure of a quality of the prediction according to the prediction and the reference variable;
transmitting, by the mobile terminal, the measure to a receiver outside the mobile terminal;
receiving, by the mobile terminal from a transmitter outside the mobile terminal, at least one model parameter for the model that was determined outside the mobile terminal according to the measure of the quality; and
replacing, in the mobile terminal, at least one of the model parameters of the model with the at least one model parameter for the model.

17. The method according to claim 16, further comprising:
determining, in the mobile terminal, a further variable;
determining, in the mobile terminal, a further prediction according to the further variable and the model in which the at least one model parameter for the model replaces the at least one model parameter of the model, wherein the further variable and the further prediction characterize: (i) the radio connection between the mobile terminal and the access point and/or (ii) the radio connection between the mobile terminal and the other access point and/or (iii) a further radio connection between the mobile terminal and another access point of the telecommunications network.

18. The method according to claim 17, wherein the variable is determined at a first point in time and at a first location, wherein the prediction is determined for a second point in time and for a second location, wherein: (i) the reference variable is determined at the second point in time and at the second location, or the further variable is determined at a third point in time and at a third location, and (ii) wherein the further prediction is determined for a fourth point in time and for a fourth location.

19. The method according to claim 16, wherein the model is used in the mobile terminal to determine a first estimate of the property for a specified location according to the variable or the further variable, wherein a second estimate of the property for the specified location is received in the mobile terminal from a transmitter outside the mobile terminal, wherein the second estimate was determined outside the mobile terminal according to a variable characterizing a radio connection between another mobile terminal and an access point for the other mobile terminal to the telecommunications network, and wherein the prediction is determined according to the first estimate and the second estimate.

20. The method according to claim 19, wherein the first estimate is determined with a first part of the model, and the prediction is determined with a second part of the model according to the first estimate and the second estimate.

21. The method according to claim 20, wherein: (i) the second part of the model is configured to weight the first estimate according to a weight, wherein the weight is determined according to an age of the first estimate and the prediction is determined according to the first estimate weighted by the weight, and/or (ii) the second part of the model is configured to weight the second estimate according to a weight, wherein the weight is determined according to an age of the second estimate and the prediction is determined according to the second estimate weighted by the weight.

22. The method according to claim 21, wherein the mobile terminal receives a third estimate of the property for the specified location from the transmitter or another transmitter outside the mobile terminal, wherein an age of the third estimate is determined, and wherein the prediction is determined according to the third estimate instead of the second estimate when the age of the third estimate is more recent than the age of the second estimate.

23. The method according to claim 17, wherein the variable characterizes the radio connection in a first cell of a cell-based telecommunications network and the further variable characterizes the radio connection in the first cell or a second cell of the cell-based telecommunications network.

24. A computer-implemented method for supporting a mobile terminal in a method for operating the mobile terminal, the method comprising the following steps:
receiving a measure of a quality of a prediction of a property of a radio connection between a mobile terminal and an access point of the telecommunications network, wherein the measure was determined according to a prediction and a reference variable for the property, wherein the prediction was determined in the mobile terminal with a model that has at least one model parameter;
determining, outside the mobile terminal, at least one model parameter for the model according to the measure and according to at least one further measure of a quality of a prediction of a property of a radio connection between a further mobile terminal and an access point of the further mobile terminal to the telecommunications network; and
transmitting, from a transmitter outside the mobile terminal, the at least one model parameter for the model, to the mobile terminal.

25. The method according to claim 24, wherein a variable characterizing the radio connection between another mobile terminal and an access point of the other mobile terminal to the telecommunications network is received and transmitted to the mobile terminal.

26. The method according to claim 24, wherein an estimate of the property characterizing the radio connection between another mobile terminal and an access point of the other mobile terminal to the telecommunications network at a specified location is received and transmitted to the mobile terminal.

27. A mobile terminal configured to:
determine, in the mobile terminal, a variable characterizing a radio connection between the mobile terminal and an access point of a telecommunications network;
determine, in the mobile terminal, using a model that is configured to predict a property of the radio connection and/or of a radio connection between the mobile terminal and another access point of the telecommunications network according to the determined variable and according to at least one model parameter, a prediction of the property according to the determined variable and the at least one model parameter;
determine, in the mobile terminal, a reference variable characterizing: (i) the radio connection between the mobile terminal and the access point and/or (ii) the radio connection between the mobile terminal and another access point, for which the prediction was determined;
determine, in the mobile terminal, a measure of a quality of the prediction according to the prediction and the reference variable;
transmit, by the mobile terminal, the measure to a receiver outside the mobile terminal;
receive, by the mobile terminal from a transmitter outside the mobile terminal, at least one model parameter for the model that was determined outside the mobile terminal according to the measure of the quality; and
replace, in the mobile terminal, at least one of the model parameters of the model with the at least one model parameter for the model.

28. A device for supporting a mobile terminal in a method for operating the mobile terminal, the device configured to:
receive a measure of a quality of a prediction of a property of a radio connection between a mobile terminal and an access point of the telecommunications network, wherein the measure was determined according to a prediction and a reference variable for the property, wherein the prediction was determined in the mobile terminal with a model that has at least one model parameter;
determine, outside the mobile terminal, at least one model parameter for the model according to the measure and according to at least one further measure of a quality of a prediction of a property of a radio connection between a further mobile terminal and an access point of the further mobile terminal to the telecommunications network; and
transmit, from a transmitter outside the mobile terminal, the at least one model parameter for the model, to the mobile terminal.

29. A non-transitory computer-readable medium on which is stored a computer program for operating a mobile terminal, the computer program, when executed by a computer, causing the computer to perform the following steps:
determining, in the mobile terminal, a variable characterizing a radio connection between the mobile terminal and an access point of a telecommunications network;
determining, in the mobile terminal, using a model that is configured to predict a property of the radio connection and/or of a radio connection between the mobile terminal and another access point of the telecommunications network according to the determined variable and according to at least one model parameter, a prediction of the property according to the determined variable and the at least one model parameter;
determining, in the mobile terminal, a reference variable characterizing: (i) the radio connection between the mobile terminal and the access point and/or (ii) the radio connection between the mobile terminal and another access point, for which the prediction was determined;
determining, in the mobile terminal, a measure of a quality of the prediction according to the prediction and the reference variable;
transmitting, by the mobile terminal, the measure to a receiver outside the mobile terminal;
receiving, by the mobile terminal from a transmitter outside the mobile terminal, at least one model parameter for the model that was determined outside the mobile terminal according to the measure of the quality; and
replacing, in the mobile terminal, at least one of the model parameters of the model with the at least one model parameter for the model.
